(19) United States
(12) Patent Application Publication
(10) Pub. No.: US 2009/0303610 A1
(43) Pub. Date: Dec. 10, 2009

(54) ZOOM LENS

(75) Inventors: TE-LUN HSU, Tu-Cheng (TW); CHUN-HSIANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/268,454

(22) Filed: Nov. 11, 2008

(30) Foreign Application Priority Data
Jun. 6, 2008 (CN) 200810302046.3

(51) Int. Cl. G02B 15/14

(52) U.S. Cl. 359/687

(57) ABSTRACT

A zoom lens includes, in this order from the object side to the image side thereof, a first lens group having positive refraction power, a second lens group having negative refraction power, a third lens group having positive refraction power, and a fourth lens group having positive refraction power. The zoom lens satisfying the formulas: 0.15<fw/f1<0.3; −0.6<f2/f3<−0.4; and 1<f4/fw<3, where fw represents the shortest effective focal length of the zoom lens, f1-f4 respectively represent the effective focal lengths of the first, second, third and fourth lens groups.

### BACKGROUND

1. Technical Field

The present disclosure relates to lenses and, particularly, to a zoom lens.

2. Description of the Related Art

Although high-ratio zoom lenses are useful and popular, they can use up a lot of space when fully extended, adding substantially to the size of compact cameras. Yet, if a low-ratio compact zoom lens is used to further reduce the size of a camera then, consumers may be dissatisfied with its capability.

Therefore, it is desirable to provide a zoom lens, which can overcome the above-mentioned problems.

### BRIEF DESCRIPTION OF THE DRAWINGS

FIGS. 1-3 are schematic views respectively showing a zoom lens that is in a wide-angle state, a medium-angle, and a telephoto state, according to an exemplary embodiment.

FIGS. 4-6 are schematic views respectively showing a zoom lens that is in a wide-angle state, a medium-angle, and a telephoto state, according to another exemplary embodiment.

FIGS. 7-8 are graphs showing field curvature and distortion occurring in the zoom lens of FIG. 1.

FIGS. 9-10 are graphs showing field curvature and distortion occurring in the zoom lens of FIG. 2.

FIGS. 11-12 are graphs showing field curvature and distortion occurring in the zoom lens of FIG. 3.

FIGS. 13-14 are graphs showing field curvature and distortion occurring in the zoom lens of FIG. 4.

FIGS. 15-16 are graphs showing field curvature and distortion occurring in the zoom lens of FIG. 5.

FIGS. 17-18 are graphs showing field curvature and distortion occurring in the zoom lens of FIG. 6.

### DETAILED DESCRIPTION OF THE EMBODIMENTS

Embodiments of the present zoom lens will now be described in detail with references to the accompanying drawings.

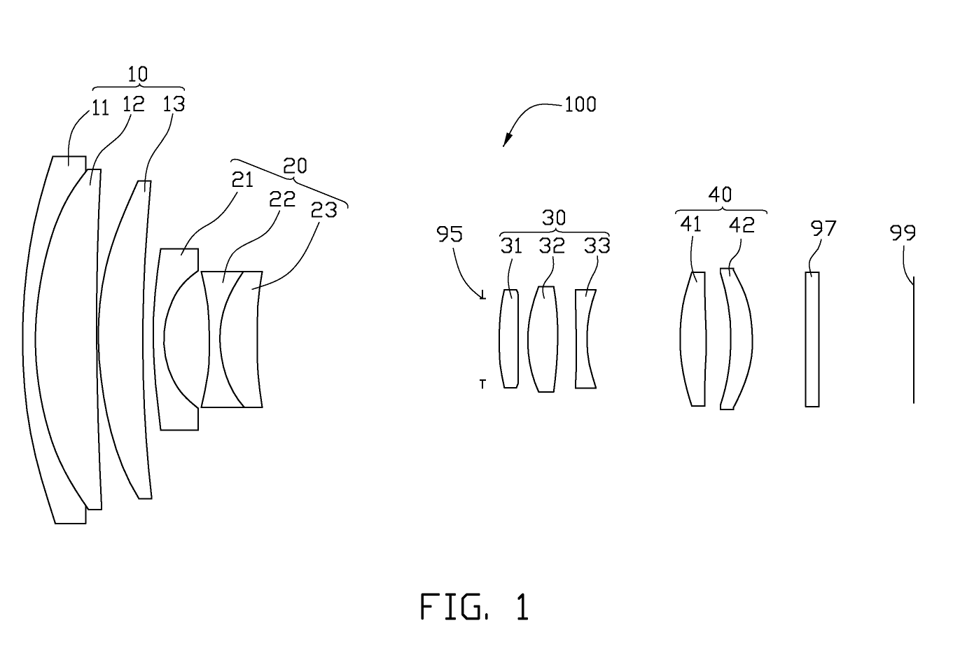

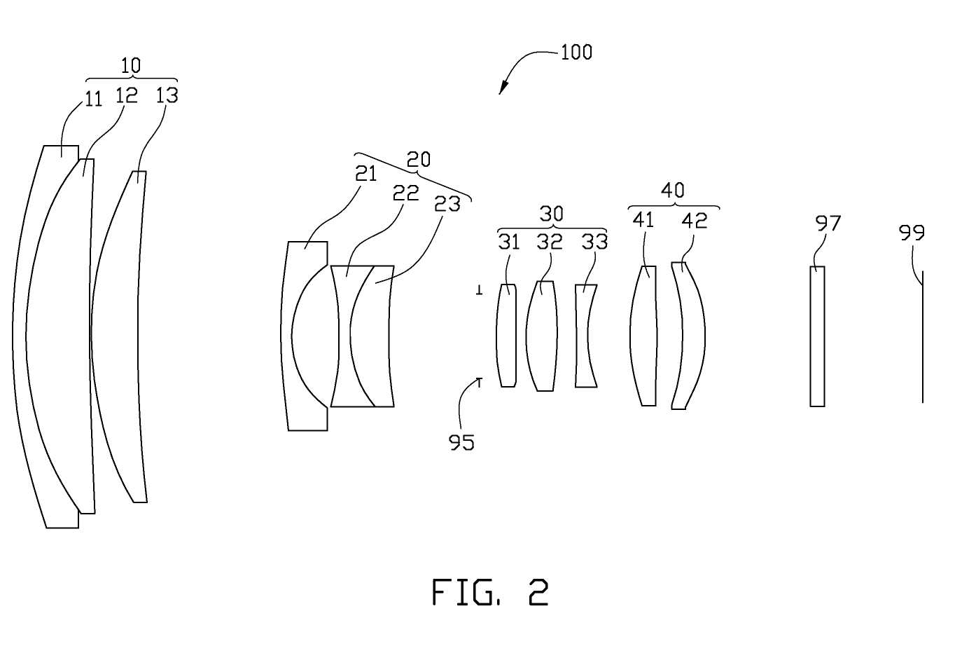

Referring to FIGS. 1-3, a zoom lens 100, according to an exemplary embodiment, includes, in order from the object side to the image side thereof, a first lens group 10, a second lens group 20, a third lens group 30, and a fourth lens group 40, wherein the first, third and fourth lens groups 10, 30, 40 have positive refraction power, while the second lens group 20 has negative refraction power.

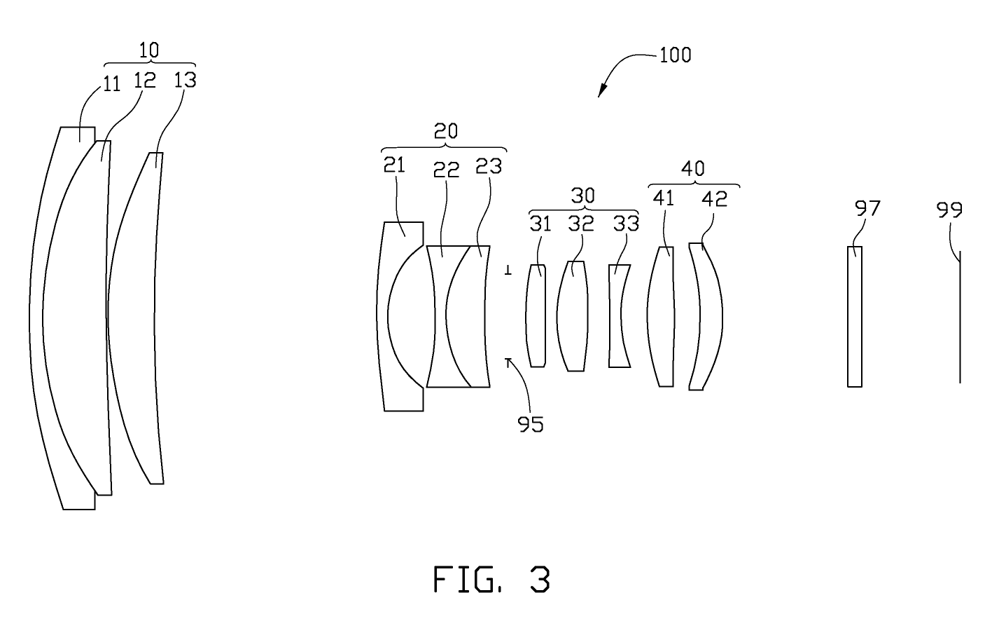

In assembly, the lens groups 10-40 are coaxially assembled into a lens accommodator (not shown), e.g., a lens barrel, and thereby form a common optical axis therebetween, wherein the first and third lens groups 10, 30 are fixedly assembled, while the second and fourth lens groups 20, 40 are assembled so as to be slidable along the common optical axis. Thereby, the effective focal length of the zoom lens 100 is variable by sliding the second and fourth lens groups 20, 40. In particular, the effective focal length of the zoom lens 100 is reduced by either moving the second lens group 20 toward the image side of the zoom lens 100 or moving the fourth lens group 40 toward the object side of the zoom lens 100 until the zoom lens 100 is in a wide-angle state with the shortest focal length, as shown in FIG. 1. In contrast, the effective focal length of the zoom lens 100 will be increased when the second lens group 20 is moved toward the object side of the zoom lens 100 or the fourth lens group 40 is moved toward the image side of the zoom lens 100 until the zoom lens 100 is in a telephoto state with the longest focal length, as shown in FIG. 3.

The zoom lens 100 can be fixed within an image capturing device, such as a digital still camera, so that when the zoom lens 100 is in the telephoto state (fully extended) it is still wholly contained within the housing of the device.

In order to obtain a zoom lens with short overall length but having high zoom ratio and high resolution, the zoom lens 100 satisfies the following formulas:

0.15<fw/f1<0.3; (1)

1<f4/fw<3; (2)

−0.6<f2/f3<−0.4, (3)

where fw represents the shortest effective focal length of the zoom lens 100, f1-f4 respectively represent the effective focal lengths of the first, second, third and fourth lens groups 10-40.

Formula (1) can favorably limit the overall length of a lens that has a ‘positive-negative-positive-positive’ refraction power configuration while maintaining high resolution. Specifically, if fw/f1<0.3 is not satisfied, the overall length of the zoom lens 100 will extend to an unacceptable range. If fw/f1>0.15 is not satisfied, the resolution of the zoom lens 100 may suffer.

Formula (2) is for obtaining a telecentric lens with short overall length. Specifically, f4/fw>1 is for overall length control of the zoom lens 100, while f4/fw<3 is for qualifying the zoom lens 100 as a telecentric lens.

Formula (3) is for aberration correction and zoom ratio enhancement. Detailedly, if the f2/f3<−0.4 is not satisfied, the distortion occurring in the zoom lens 100 becomes unacceptable. If f2/f3>−0.6 is not satisfied, the zoom ratio of the zoom lens 100 is in an undesirable range, for example, zoom ratio <5.

In this embodiment, the first lens group 10 includes, from the object side to the image side of the zoom lens 100, a first lens 11, a second lens 12, and a third lens 13. The first lens 11 has negative refraction power. The second and third lenses 12, 13 have positive refraction power. The first and second lenses 11, 12 are unified as a compound lens using adhesive.

The second lens group 20 includes, from the object side to the image side of the zoom lens 100, a fourth lens 21, a fifth lens 22, and a sixth lens 23. Both the fourth and fifth lenses 21, 22 have negative refraction power. The sixth lens 23 has positive refraction power. The fifth and sixth lenses 22, 23 are unified as a compound lens using adhesive too.

The third lens group 30 includes, from the object side to the image side of the zoom lens 100, a seventh lens 31, a eighth lens 32, and a ninth lens 33. The seventh and eighth lenses 32, 33 have positive refraction power. The ninth lens 33 has negative refraction power. Furthermore, in order to efficiently correcting aberrations occurring in the first and second lens groups 10-20, at least one of the seventh, eighth or ninth lenses 31-33 is an aspheric lens. In this embodiment, the eighth lens 32 is an aspheric lens. The aspheric surface is shaped according to the formula:

$$x = \frac{{ch}^{2}}{1 + \sqrt{1 - ( k + 1 ) {c}^{2} {h}^{2}}} + {\sum }^{ } {Aih}^{i} ,$$

where h is a height from the optical axis of the imaging lens 100 to the aspheric surface, c is a vertex curvature, k is a conic constant, and Ai are i-th order correction coefficients of the aspheric surfaces.

The fourth lens group 40 includes, from the object side to the image side of the zoom lens 100, a tenth lens 41 with positive refraction of power, and a eleventh lens 42 with negative refraction power. Also for aberration correction purposes, at least one of the tenth and eleventh lenses 41-42 is an aspheric lens. In this embodiment, the tenth lens 41 is an aspheric lens.

To reduce cost of the zoom lens 100, the aspheric lenses may be made from plastic. To prevent too much chromatic aberration from occurring in the zoom lens 100, the spherical lenses of the zoom lens 100, e.g., lenses 11-13, 21-23, 31, 33, 42 may be made from glass.

In use, light enters the zoom lens 100, and travels through the first, second, third, and fourth lens groups 10-40, and finally is focused on the image plane of the zoom lens 100 where an image sensor 99 such as a charge-coupled device (CCD) or a complementary metal oxide semiconductor (CMOS) is located.

Optionally, the zoom lens 100 may further include an aperture stop 95. The aperture stop 95 is interposed between the lens groups 20 and 30 (the lenses 23, 31) to block off-axis light rays from the sixth lens 23 entering the seventh lens 31, and thereby preventing too much distortion occurring in the zoom lens 100 (the off-axis light rays are the main cause of distortion).

Additionally, the zoom lens may further include a cover glass 97. The cover glass is to provide mechanical protection and optical sealing for the image sensor 99.

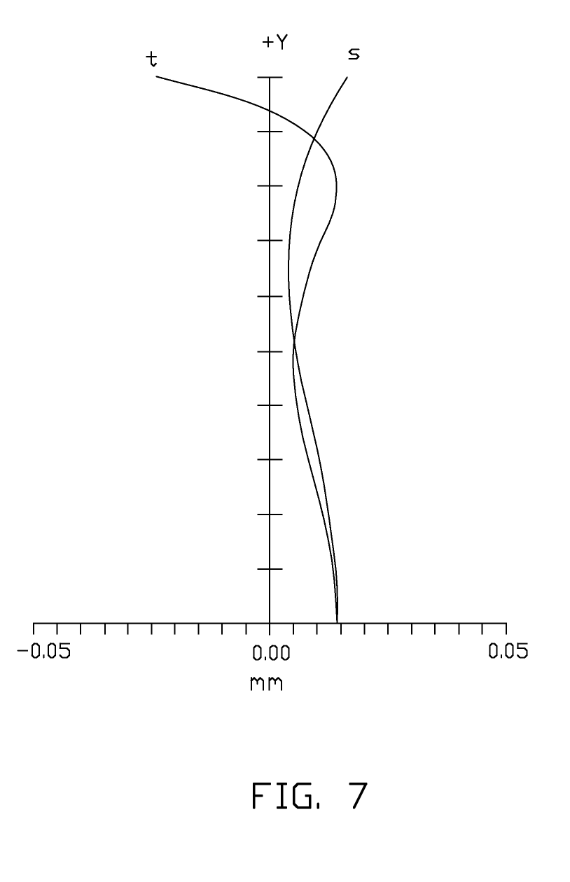

Detailed example of the zoom lens 100 is given below in company with FIGS. 7˜12 but it should be noted that the zoom lens 100 is not limited to this example. Listed below are the symbols used in the detailed example:

F: effective focal length of the zoom lens 100;

F_{No}: F number;

2ω: field angle;

R: radius of curvature;

d: distance between surfaces on the optical axis of the zoom lens 100;

Nd: refractive index of lens; and

V: Abbe constant.

### EXAMPLE

Tables 1-3 show the lens data of the Example.

TABLE 1

| Surfaces | R (mm) | D (mm) | Nd | Vd |
|---|---|---|---|---|
| Object-side surface of the first lens | 33.05 | 0.8 | 1.85 | 23.8 |
| Interface between the first and second lenses | 18.5 | 3.84 | 1.49 | 81.6 |
| Image-side surface of the second lens | 180.5 | 0.1 | — | — |
| Object-side surface of the third lens | 21.92 | 2.7 | 1.8 | 46.5 |
| Image-side surface of the third lens | 80.55 | D5 (see table 2) | — | — |
| Object-side surface of the fourth lens | 35.4 | 0.6 | 1.83 | 37.3 |
| Image-side surface of the fourth lens | 5.19 | 2.7 | — | — |
| Object-side surface of the fifth lens | −17.41 | 0.7 | 1.49 | 81.6 |
| Interface between the fifth and sixth lenses | 6.3 | 2.2 | 1.84 | 23.8 |
| Object-side surface of the sixth lens | 24.38 | D10 (see table 2) | — | — |
| Surface of the aperture stop | infinite | 1 | — | — |
| Object-side surface of the seventh lens | 14.05 | 1.1 | 1.48 | 70.4 |
| Image-side surface of the seventh lens | −67.85 | 0.5 | — | — |
| Object-side surface of the eighth lens | 7.38 | 1.8 | 1.53 | 55.8 |
| Image-side surface of the eighth lens | −21.51 | 1.1 | — | — |
| Object-side surface of the ninth lens | −42.78 | 0.7 | 1.84 | 23.8 |
| Image-side surface of the ninth lens | 7.78 | D17 (see table 2) | — | — |
| Object-side surface of the tenth lens | −11.68 | 1.5 | 1.53 | 55.8 |
| Image-side surface of the tenth lens | −32.5 | 1.5 | — | — |
| Object-side surface of the eleventh lens | −10.98 | 1.3 | 1.48 | 70.4 |
| Image-side surface of the eleventh lens | −8.09 | D21 (see table 2) | — | — |
| Object-side surface of the cover glass | infinite | 0.8 | 1.51 | 64.2 |
| Image-side surface of the cover glass | infinite | 5.95 | — | — |
| Image plane | infinite | — | — | — |

TABLE 2

| Lens state | F (mm) | F_{No} | 2ω | D5 (mm) | D10 (mm) | D17 (mm) | D21 (mm) |
|---|---|---|---|---|---|---|---|
| Wide-angle | 6.3 | 3.3 | 59.1° | 0.70 | 14.00 | 5.80 | 3.30 |
| Medium-angle | 16.5 | 3.5 | 23.8° | 9.00 | 5.40 | 2.54 | 6.60 |
| Telephoto | 31.5 | 3.7 | 12.5° | 13.30 | 1.37 | 1.69 | 7.47 |

TABLE 3

| Surfaces | Aspheric coefficient |
|---|---|
| Object-side surface of the | k = −1.17; A₄ = 0.000218; A₆ = −0.0000031; |
| eighth lens | A₈ = −0.00000101; A₁₀ = 0.000000132 |
| Image-side surface of the | k = −47.58; A₄ = −0.000394; A₆ = 0.0000145; |
| eighth lens | A₈ = −0.00000136; A₁₀ = 0.0000000751 |
| Object-side surface of the | k = 3.123; A₄ = 0.0000461; A₆ = −0.00000689; |
| tenth lens | A₈ = 0.000000514; A₁₀ = −0.0000000263 |
| Image-side surface of the | k = 0.683; A₄ = 0.000657; A₆ = 0.0000047; |
| tenth lens | A₈ = 0.000000243; A₁₀ = −0.0000000143 |

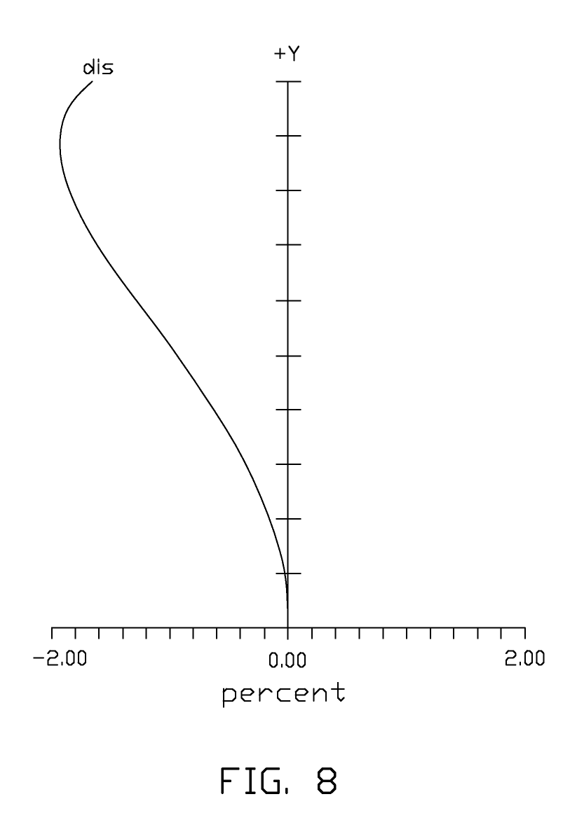

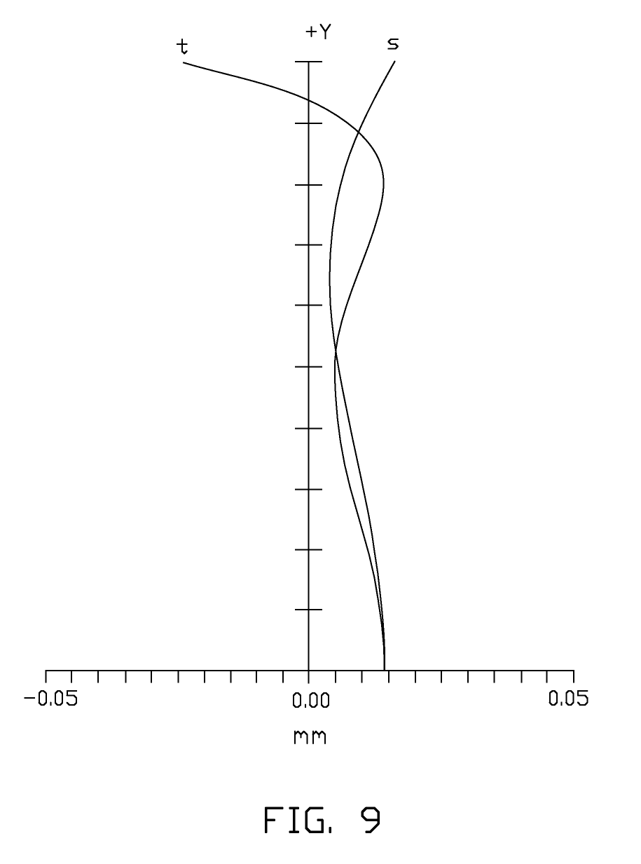

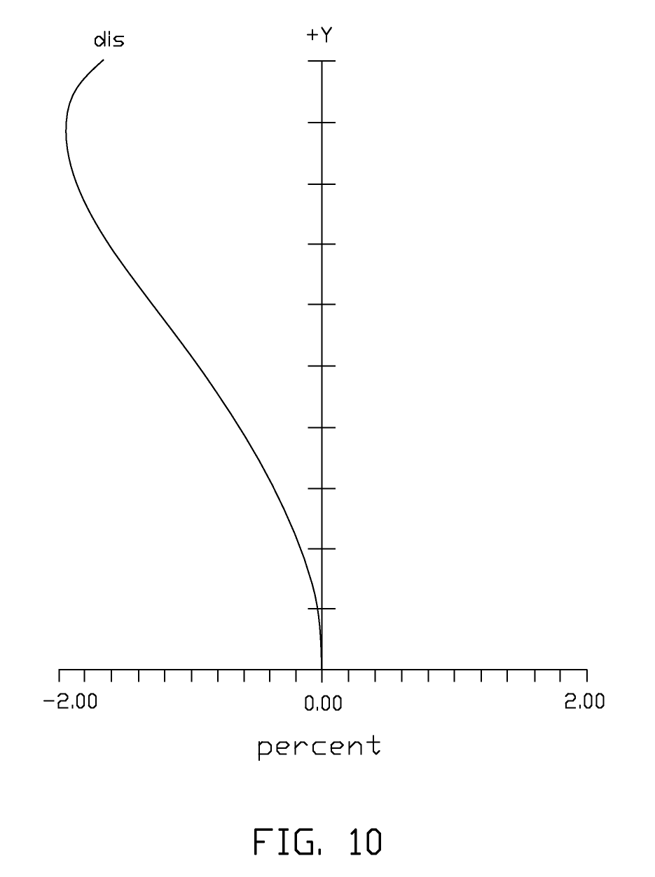

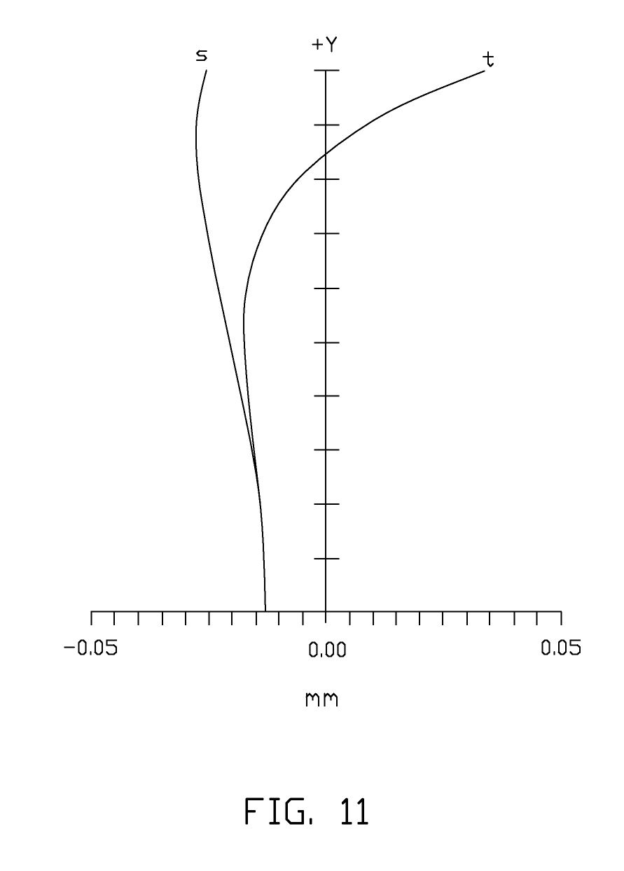

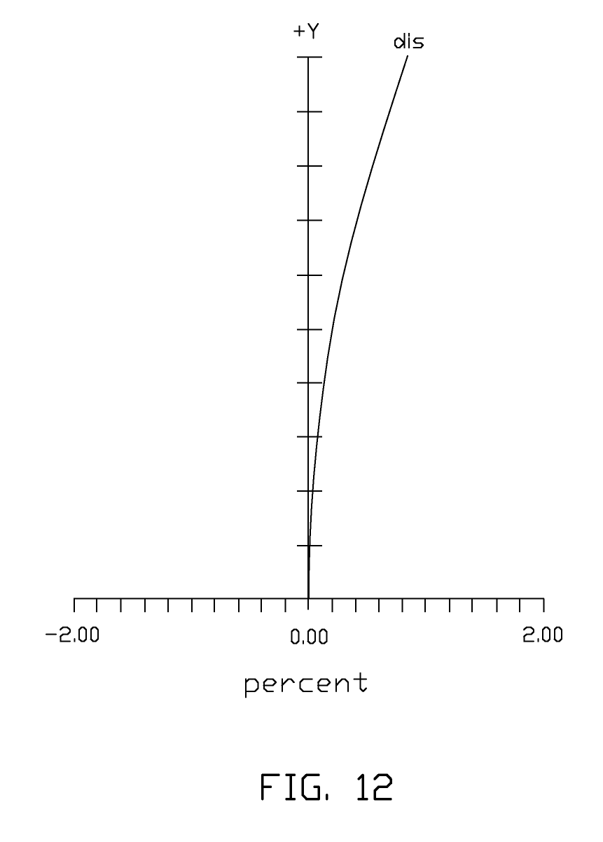

The curves t and s of FIGS. 7, 9, 11 are the tangential field curvature curve and the sagittal field curvature curve respectively of the zoom lens. The dis curves in FIGS. 8, 10, 12, are distortion curves of the zoom lens 100. As shown in the FIGS. 7-12, field curvature occurring in the zoom lens 100 over the entire zoom range including the wide-angle state, the medium state, and the telephoto state is controlled to be within the range from −0.05 mm to 0.05 mm; and distortion is limited −2%˜2%.

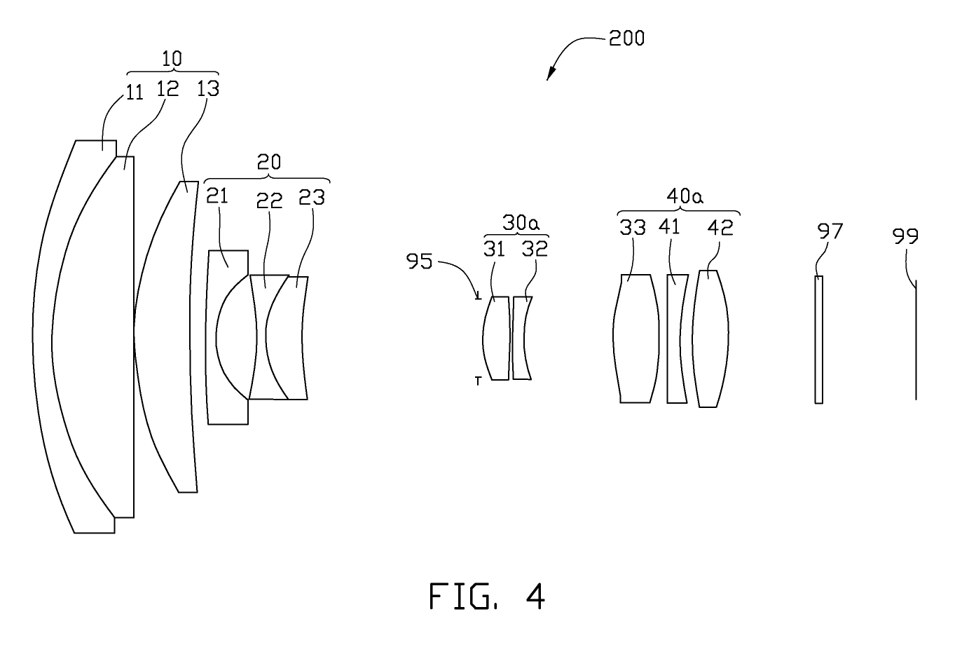

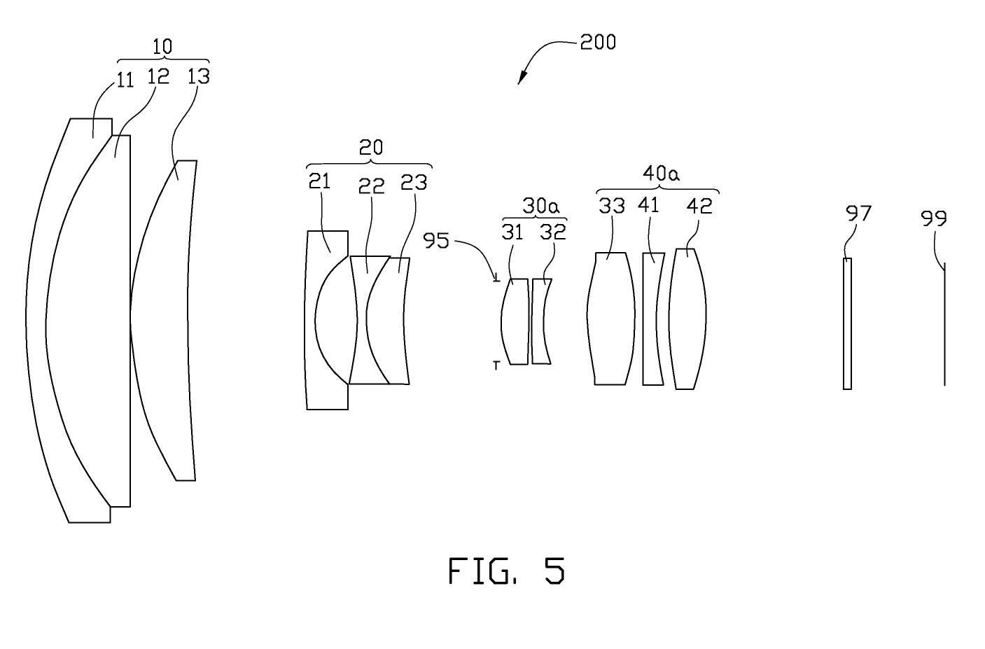

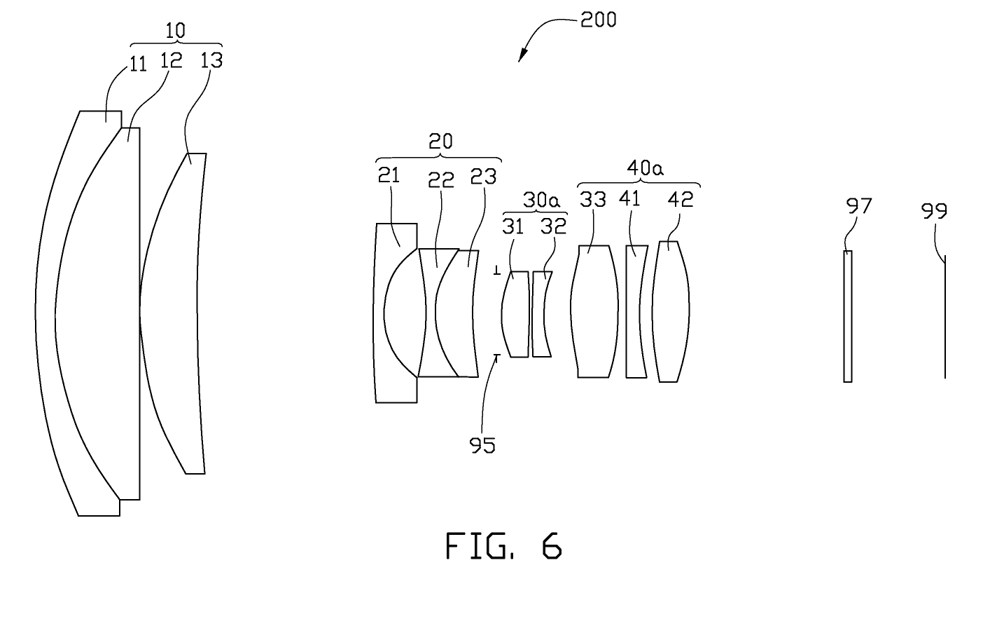

Referring to FIGS. 4-6, a zoom lens 200, according to another embodiment, is substantially similar to the zoom lens 100 except with respect to the grouping properties of the zoom lens 200 and the locations of the aspheric lenses. In this embodiment, the seventh and eighth lenses 31-32 are grouped as a three lens group 30a of the zoom lens 200. The ninth, tenth, and eleventh lenses 33, 41-42 are grouped as a fourth lens group 40a of the zoom lens 200. The seventh and ninth lenses 31, 33 are aspheric lenses.

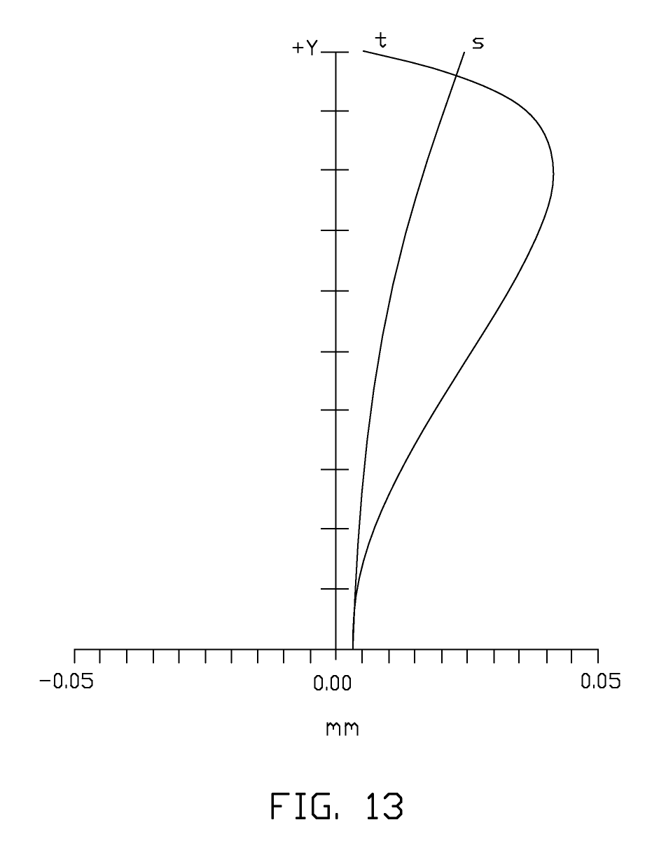

Detailed example of the zoom lens 200 is given below in company with FIGS. 13˜18, but it should be noted that the zoom lens 200 is not limited to this example.

### EXAMPLE

Tables 4-7 show the lens data of the Example.

TABLE 4

| Surfaces | R (mm) | D (mm) | Nd | Vd |
|---|---|---|---|---|
| Object-side surface of the first lens | 29.34 | 1.2 | 1.85 | 23.8 |
| Interface between the first and second lenses | 17.49 | 5.02 | 1.49 | 70.4 |
| Image-side surface of the second lens | infinite | 0.1 | — | — |
| Object-side surface of the third lens | 17.57 | 3.35 | 1.72 | 54.6 |
| Image-side surface of the third lens | 77.39 | D5 (see table 5) | — | — |
| Object-side surface of the fourth lens | 81.6 | 0.65 | 1.83 | 37.3 |
| Image-side surface of the fourth lens | 4.81 | 2.49 | — | — |
| Object-side surface of the fifth lens | −16.85 | 0.6 | 1.48 | 70.4 |
| Interface between the fifth and sixth lenses | 5.67 | 2.24 | 1.84 | 23.8 |
| Object-side surface of the sixth lens | 18.59 | D10 (see table 5) | — | — |
| Surface of the aperture stop | infinite | 0.3 | — | — |
| Object-side surface of the seventh lens | 6.05 | 1.75 | 1.49 | 70.2 |
| Image-side surface of the seventh lens | −25.42 | 0.15 | — | — |
| Object-side surface of the eighth lens | 45.64 | 0.7 | 1.54 | 47.2 |
| Image-side surface of the eighth lens | 6.82 | D15 (see table 5) | — | — |
| Object-side surface of the ninth lens | 11.76 | 2.86 | 1.48 | 70.2 |
| Image-side surface of the ninth lens | −14.12 | 0.48 | — | — |
| Object-side surface of the tenth lens | infinite | 0.8 | 1.83 | 37.3 |
| Image-side surface of the tenth lens | 16.09 | 0.8 | — | — |
| Object-side surface of the eleventh lens | 23.09 | 2.23 | 1.49 | 81.6 |
| Image-side surface of the eleventh lens | −12.09 | D21 (see table 5) | — | — |
| Object-side surface of the cover glass | infinite | 1 | 1.51 | 64.2 |
| Image-side surface of the cover glass | infinite | 5.3 | — | — |
| Image plane | infinite | — | — | — |

TABLE 5

| Lens state | F (mm) | F_{No} | 2ω | D5 (mm) | D10 (mm) | D15 (mm) | D21 (mm) |
|---|---|---|---|---|---|---|---|
| Wide-angle | 6.35 | 3.0 | 51.5° | 1.05 | 10.97 | 5.56 | 5.34 |
| Medium-angle | 18.4 | 3.7 | 21.3° | 7.99 | 4.03 | 2.12 | 8.78 |
| Telephoto | 30.4 | 4.7 | 20.1° | 10.68 | 1.34 | 1.68 | 9.22 |

TABLE 3

| Surfaces | Aspheric coefficient |
|---|---|
| Object-side surface of the | k = −1.17; A₄ = 0.000218; A₆ = −0.0000031; |
| seventh lens | A₈ = −0.00000101; A₁₀ = 0.000000132 |
| Image-side surface of the | k = −47.58; A₄ = −0.000394; A₆ = 0.0000145; |
| seventh lens | A₈ = −0.00000136; A₁₀ = 0.0000000751 |
| Object-side surface of the | k = 3.123; A₄ = 0.0000461; A₆ = −0.00000689; |
| ninth lens | A₈ = 0.000000514; A₁₀ = −0.0000000263 |
| Image-side surface of the | k = 0.683; A₄ = 0.000657; A₆ = 0.0000047; |
| ninth lens | A₈ = 0.000000243; A₁₀ = −0.0000000143 |

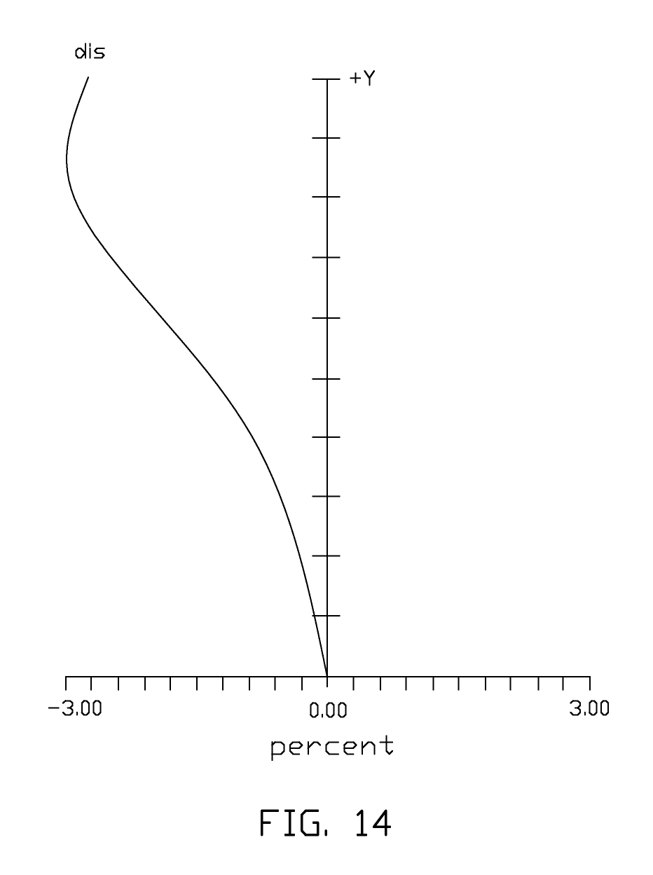

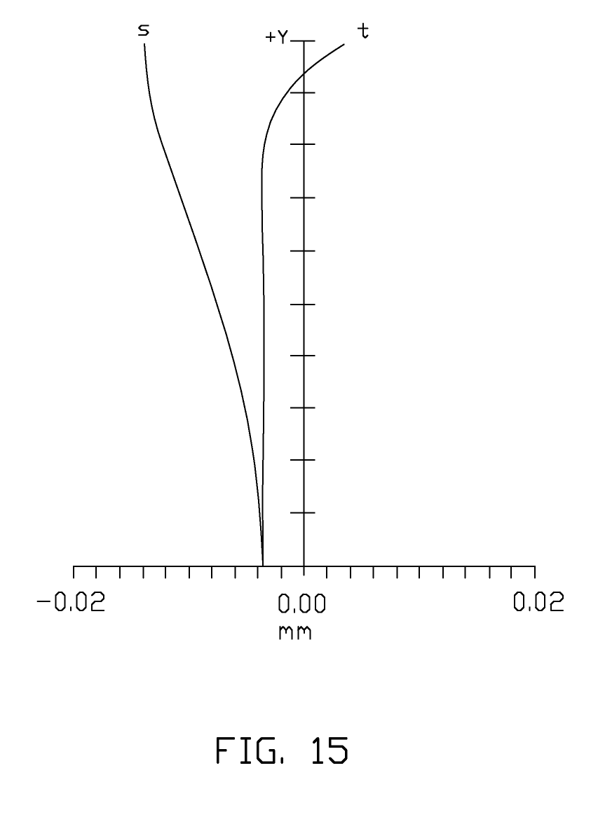

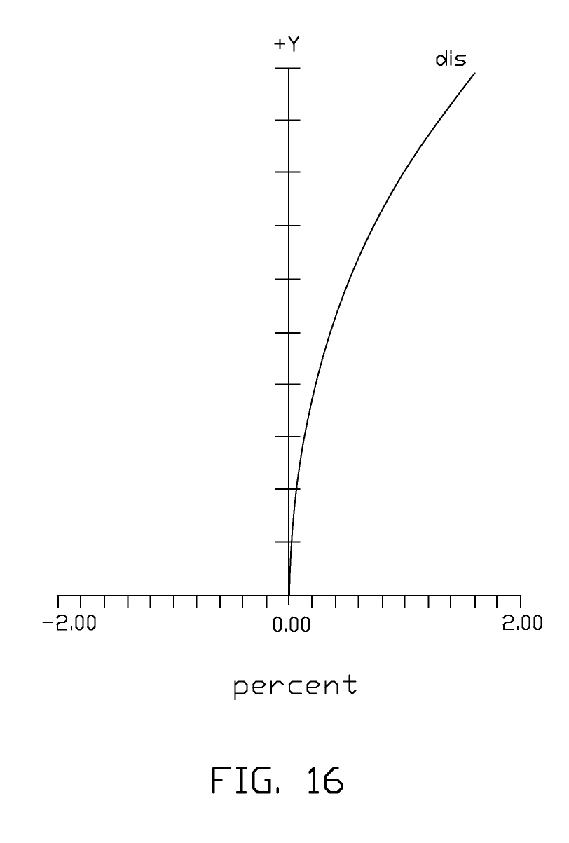

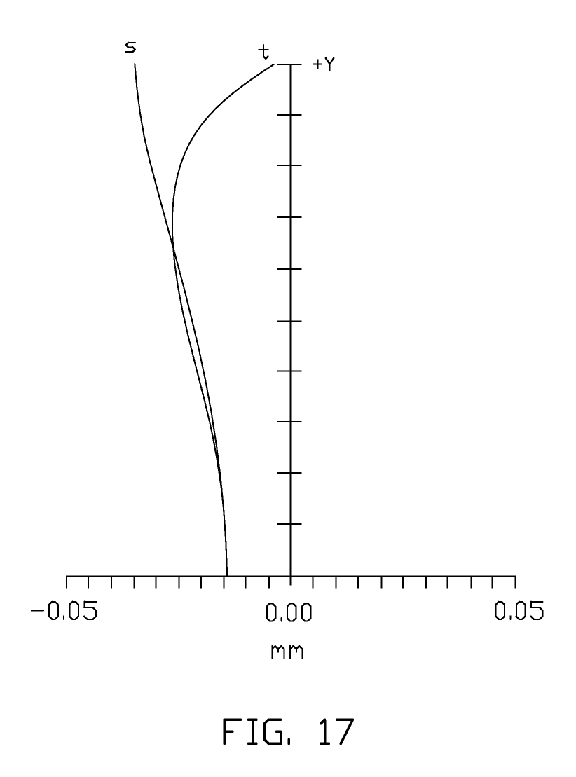

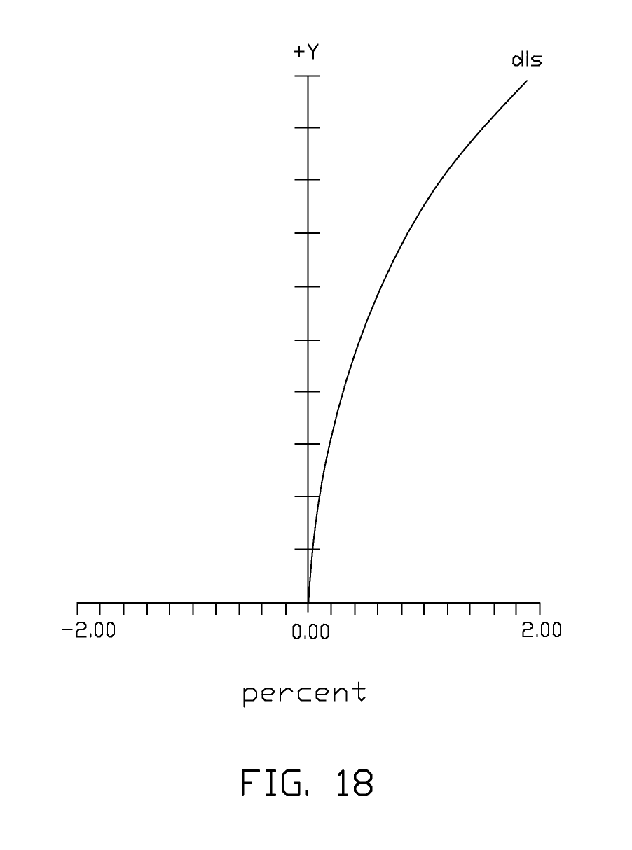

As shown in the FIGS. 13-18, field curvature occurring in the zoom lens 200 over the entire zoom range including the wide-angle state, the medium state, and the telephoto state is controlled to be within the range from −0.05 mm to 0.05 mm; and distortion is limited to −3%˜3%.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A zoom lens comprising, in this order from the object side to the image side thereof:
a first lens group having positive refraction power;
a second lens group having negative refraction power;
a third lens group having positive refraction power; and
a fourth lens group having positive refraction power,
the lens groups satisfying the formulas: 0.15<fw/f1<0.3; −0.6<f2/f3<−0.4; and 1<f4/fw<3, where fw represents the shortest effective focal length of the zoom lens, f1-f4 respectively represent the effective focal lengths of the first, second, third and fourth lens groups.

2. The zoom lens as claimed in claim 1, wherein the first and second lens groups are each constituted by at least three lenses.

3. The zoom lens as claimed in claim 1, wherein the third lens group comprises an aspheric lens.

4. The zoom lens as claimed in claim 3, wherein the aspheric lens is made of plastic.

5. The zoom lens as claimed in claim 1, wherein the fourth lens group comprises an aspheric lens.

6. The zoom lens as claimed in claim 5, wherein the aspheric lens is made of plastic.

7. The zoom lens as claimed in claim 1, further comprising an aperture stop, the aperture stop being interposed between the second and third lens groups.

8. The zoom lens as claimed in claim 7, wherein the first and second lenses are unified.

9. The zoom lens as claimed in claim 1, wherein the second lens group comprises, from the object side to the image side of the zoom lens, a fourth lens of negative refraction power, a fifth lens of negative refraction power, and a sixth lens of positive refraction power.

10. The zoom lens as claimed in claim 9, wherein the fifth and sixth lenses are unified.

11. The zoom lens as claimed in claim 1, wherein the third lens group comprises, from the object side to the image side of the zoom lens, a seventh lens of positive refraction power, a eighth lens of positive refraction power, and a ninth lens of negative refraction power.

12. The zoom lens as claimed in claim 11, wherein the seventh lens is an aspheric lens.

13. The zoom lens as claimed in claim 11, wherein the third lens group comprises an aspheric lens.

14. The zoom lens as claimed in claim 13, wherein the aspheric lens is made of plastic.

15. The zoom lens as claimed in claim 1, wherein the fourth lens group comprises, from the object side to the image side of the zoom lens, a tenth lens of positive refraction of power, and a eleventh lens of negative refraction power.

16. The zoom lens as claimed in claim 15, wherein the tenth lens is an aspheric lens.

17 The zoom lens as claimed in claim 15, wherein the fourth lens group comprises an aspheric lens.

18. The zoom lens as claimed in claim 9, further comprising an aperture stop, the aperture stop being interposed between the second and third lens groups.

19. The zoom lens as claimed in claim 1, wherein the third lens group comprises, from the object side to the image side of the zoom lens, a seventh lens of positive refraction power, a eighth lens of negative refraction power; the seventh lens is an aspheric lens.

20. The zoom lens as claimed in claim 19, wherein the fourth lens group comprises, from the object side to the image side of the zoom lens, a ninth lens of positive refraction power, a tenth lens of negative refraction power, and a eleventh lens of positive refraction power; the ninth lens is an aspheric lens.
